(19) United States
(12) Patent Application Publication
(10) Pub. No.: US 2026/0161954 A1
(43) Pub. Date: Jun. 11, 2026

(54) TRAINING AGENT NEURAL NETWORKS FOR CONTROLLING AGENTS USING A TARGET-GENERATING NEURAL NETWORK

(71) Applicant: GDM Holding LLC, Mountain View, CA (US)

(72) Inventors: Junhyuk Oh, London (GB); Gregory Robert Farquhar, London (GB); Iurii Kemaev, London (GB); Dan-Andrei Calian, London (GB)

(21) Appl. No.: 19/412,537

(22) Filed: Dec. 8, 2025

Related U.S. Application Data
(60) Provisional application No. 63/729,246, filed on Dec. 6, 2024.

(51) Int. Cl. G06N 3/092

(52) U.S. Cl. CPC G06N 3/092

(57) ABSTRACT

Methods, systems, and apparatuses, including computer programs encoded on computer storage media, for training an agent neural network. The system obtains a training trajectory that includes a sequence of transitions, each including an observation and an action performed by an agent. For each transition, the system processes the observation using the agent neural network to generate an agent output that includes a policy output. The system processes the policy output and the action using a target-generating neural network to dynamically generate a target policy output. The system then trains the agent neural network on a loss function that measures an error between the policy output and the generated target policy output.

### CROSS-REFERENCE TO RELATED APPLICATIONS

This application claims priority of U.S. Provisional Application No. 63/729,246 filed Dec. 6, 2024. The contents of the prior application is incorporated herein by reference in its entirety.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that trains an agent neural network to control an agent interacting with an environment to perform a task.

In one aspect there is described a computer-implemented method for training an agent neural network to control a first agent in a first environment to perform a first task.

The method involves obtaining a training trajectory, the training trajectory comprising a sequence of transitions. Each transition in the sequence comprises a respective observation characterizing a state of the first environment, and an action performed by the first agent in response to the respective observation.

The method is performed for each transition in the training trajectory. This involves processing an agent input comprising the respective observation in the transition, using the agent neural network, to generate an agent output. The agent output comprises a policy output that defines a respective score for each action in a set of actions; i.e., the policy output can comprise a distribution (continuous or categorical) over the set of actions. A target-generating input that comprises the policy output (i.e., the distribution over actions), and the action in the transition, is processed using a target-generating neural network to generate a target-generating output that comprises a target policy output.

The agent neural network is trained on a loss function that comprises a policy loss that measures, for each transition, an error between the policy output for the transition and the target policy output for the transition generated by the target-generating neural network.

According to a second aspect there is provided a method performed by one or more computers and for training an agent neural network to control a first agent in a first environment to perform a first task that comprises obtaining a training trajectory, the training trajectory comprising a sequence of transitions, each transition in the sequence comprising a respective observation characterizing a state of the first environment and an action performed by the first agent in response to the respective observation; for each transition in the training trajectory: processing an agent input comprising the respective observation in the transition using the agent neural network to generate an agent output that comprises a policy output that defines a respective score for each action in a set of actions; and processing a target-generating input that comprises the policy output and the action in the transition using a target-generating neural network to generate a target-generating output that comprises a target policy output; and training the agent neural network on a loss function that comprises a policy loss that measures, for each transition, an error between the policy output for the transition and the target policy output for the transition generated by the target-generating neural network.

In some cases of the second aspect, the target-generating input does not include the respective observation in the transition.

In some cases of the second aspect, each transition further comprises a respective reward received in response to the first agent performing the action in the transition and wherein the target-generating input further comprises the respective reward.

In some cases of the second aspect, the agent output further comprises a state-conditional prediction vector, the target-generating input further comprises the state-conditional prediction vector, the target-generating output further comprises a target state-conditional prediction vector, and the loss function further comprises a state-condition prediction loss that measures, for each transition, an error between the state-conditional prediction vector for the transition and the target state-conditional prediction vector for the transition generated by the target-generating neural network.

In some cases of the second aspect, the state-conditional prediction vector is a latent vector in a first latent space.

In some cases of the second aspect, the agent output further comprises a respective action-conditional prediction vector for each of at least a subset of the actions, the target-generating input further comprises the respective action-conditional prediction vectors, the target-generating output further comprises a respective target action-conditional prediction vector for each of at least the subset of the actions, and the loss function further comprises an action-condition prediction loss that measures, for each transition and for each of at least the subset of the actions, an error between the respective action-conditional prediction vector for the action and the respective target action-conditional prediction vector for the action generated by the target-generating neural network.

In some cases of the second aspect, each respective action-conditional prediction vector is a respective latent vector in a second latent space.

In some cases of the second aspect, the target-generating input further comprises an indicator variable that indicates whether the transition was a terminal transition in a task episode.

In some cases of the second aspect, the target-generating neural network is configured to, prior to processing a first transition in the sequence: initialize a first hidden state of the target-generating neural network, and for each transition: process the target-generating input for the transition to update the first hidden state of the target-generating neural network, and after updating the first hidden state, process a decoder input comprising the first hidden state using one or more decoder neural network heads to generate the target-generating output.

In some cases of the second aspect, transitions are arranged within the sequence according to a respective time step for each transition and wherein the first transition in the sequence is a transition with a latest time step.

In some cases of the second aspect, the agent neural network is trained on a sequence of trajectories that comprises the trajectory, wherein the target-generating neural network is configured to, prior to training the agent neural network: initialize a second hidden state of the target-generating neural network, and for each trajectory in the sequence, process the transitions in the trajectory to update the second hidden state.

In some cases of the second aspect, the decoder input comprises the second hidden state after being updated for a preceding trajectory in the sequence.

In some cases of the second aspect, processing the transitions in the trajectory to update the second hidden state comprises: processing the transitions in the trajectory using an embedding neural network to generate an embedding of the trajectory; and processing the embedding of the trajectory and the second hidden state using a recurrent neural network to update the second hidden state.

In some cases of the second aspect, the agent output further comprises a respective action-value estimate for each of at least a subset of the actions.

In some cases of the second aspect, the target-generating input further comprises the respective action-value estimates.

In some cases of the second aspect, the loss function further comprises an action-value estimate loss that measures, for each transition, an error between the respective action-value estimates for the actions for the transition and a temporal-difference target for the transition.

In some cases of the second aspect, the target-generating neural network has been trained through meta-learning on a meta-learning objective that measures a performance of a plurality of training agent neural networks in controlling respective training agents in respective training environments.

In some cases of the second aspect, the agent neural network has more parameters than the training agent neural networks.

In some cases of the second aspect, the agent neural network has a different architecture than the training agent neural networks.

In some cases of the second aspect, two or more of the respective training agents are different from one another.

In some cases of the second aspect, two or more of the respective training environments are different from one another.

In some cases of the second aspect, the meta-learning objective measures an expected time-discounted sum of rewards received by an agent controlled by one of the plurality of training agent neural networks.

In some cases of the second aspect, training the target-generating neural network on the meta-learning objective comprises repeatedly performing the following: determining an estimate of a meta-gradient; determining an estimate of a policy gradient; and updating parameters of the target-generating neural network using the estimate of the meta-gradient and the estimate of the policy gradient.

In some cases of the second aspect, determining the estimate of the meta-gradient comprises: instantiating a population of training agents that are each controlled by a respective training agent neural network; training each of the training agent neural networks using the target-generating neural network; and backpropagating through the training of each of the training agent neural networks to generate the estimate of the meta-gradient.

In some cases of the second aspect, determining an estimate of a policy gradient comprises: determining the estimate of the policy gradient using an actor-critic reinforcement learning technique.

In some cases of the second aspect, the method further comprises controlling the first agent using policy outputs generated by the agent neural network to generate the trajectory.

In some cases of the second aspect, the method further comprises, after the training, controlling the first agent using policy output generated by the agent neural network to perform instances of the first task.

In some cases of the second aspect, the first agent is a mechanical agent and the first environment is a real-world environment.

In some cases of the second aspect, the first agent is a robot.

In some cases of the second aspect, the first environment is a real-world environment of a service facility comprising a plurality of items of electronic equipment and the first agent is an electronic agent configured to control operation of the service facility.

In some cases of the second aspect, the first environment is a real-world manufacturing environment for manufacturing a product and the first agent comprises an electronic agent configured to control a manufacturing unit or a machine that operates to manufacture the product.

In some cases of the second aspect, the first environment is a simulation of a real-world environment, and wherein the method further comprises: after the training, controlling a real-world agent in the real-world environment using the agent neural network.

In some cases of the second aspect, the first environment is a data item compression environment; the first task is to compress an input data item, each state of the environment corresponds to a respective state of the compression of the input data item; and the actions correspond to encoding decisions during the compression of the input data item.

In some cases of the second aspect, the first environment is a chip design environment; the first task is to generate a chip design for a computer chip that satisfies an input specification, the state of the first environment corresponds to a respective state of the chip design; and the actions correspond to chip design decisions during the generation of the chip design.

In some cases of the second aspect, the first environment is an algorithm optimization environment; the first task is to generate a computer program that optimizes a target algorithm for execution on a target processor, each state of the first environment corresponds to a respective state of the generation of the computer program; and the actions each apply a respective modification to the computer program.

In some cases of the second aspect, the first environment is an algorithm optimization environment; the first task is to generate a sequence of modifications to a tensor that represent an algorithm that optimizes a target algorithm for execution on a target processor, each state of the first environment corresponds to a respective state of the tensor; and the actions each apply a respective modification to the tensor.

In some cases of the second aspect, the first environment is a computer system that comprises a plurality of computing devices; the first task is to allocate one or more computational workloads across the plurality of computing devices, each state of the environment corresponds to a respective state of the computer system given a current allocation of the one or more computational workloads; and the actions each apply a respective modification to the current allocation.

In some cases of the second aspect, the first environment is a video game environment and the first agent is a first software agent in the video game.

In some cases of the second aspect, the agent neural network comprises: an encoder configured to encode the agent input to generate an encoded representation; and one or more neural network heads that are configured to process the encoded representation to generate the agent output.

According to a third aspect there is provided the methods of the first aspect or second aspect performed by a system comprising: one or more computers; and one or more storage devices storing instructions that, when executed by the one or more computers, cause the one or more computers to perform the respective operations of the respective method.

According to a fourth aspect, there is provided the methods of the first aspect or second aspect performed by one or more computer-readable storage media storing instructions that when executed by one or more computers cause the one or more computers to perform the respective operations of the respective method.

Particular embodiments of the subject matter described in this specification can be implemented so as to realize one or more of the following advantages.

Existing reinforcement learning systems that train agent neural networks typically rely on static, manually designed update “rules” to train agent neural networks. These handcrafted algorithms are often rigid and may not be optimal for specific environments or tasks, leading to inefficient use of computational resources and slow convergence rates. Furthermore, designing effective auxiliary tasks or state representations to aid the training of an agent neural network often requires extensive domain knowledge and trial-and-error engineering. Existing automated methods for discovering update rules are often computationally expensive or limited to simple environments, failing to scale to complex, high-dimensional tasks. Consequently, there is a need for a dynamic update rule that can be optimized for the specific agent and environment without relying on fixed, manually designed algorithms.

This specification describes techniques that can address the aforementioned challenges by training an agent neural network using a target-generating neural network (which serves as a dynamic update rule). The described techniques process an agent input that includes a respective observation in a transition included in a training trajectory using the agent neural network to generate an agent output that includes a policy output. The described techniques then process a target-generating input that includes the policy output and an action in the transition of the trajectory using the target-generating neural network to generate a target-generating output that includes a target policy output. The described techniques then train the agent neural network on a loss function that includes a policy loss that measures an error between the policy output and the target policy output generated by the target-generating neural network.

The target-generating neural network is a dynamic update rule because the target-generating outputs used to train the agent neural network are not determined by a static formula but are instead outputted by a target-generating neural network that adapts its target-generation strategy based on a target-generating input that includes elements of the transition and agent output. Thus, the described techniques provide a dynamic update rule where the rule itself is parameterized by a neural network (the target-generating neural network), rather than relying on fixed definitions of targets.

By processing a target-generating input that includes the policy output, i.e., a distribution, and the action using a target-generating neural network to generate a target policy output, the described techniques enable a dynamic update rule that improves computational efficiency and machine learning performance. For example, by using the full policy output (a distribution that defines a respective score for each action), the system has access to the probabilities of actions not taken as well as to that of a selected action. This facilitates the system discovering reinforcement learning rules, particularly in complex environments.

Further, in some implementations the agent output includes an action-conditional prediction vector for processing using the target-generating neural network. This can help the system to learn rules that are conceptually similar to action-value functions, usefully increasing the space of discovered rules.

The described techniques improve computational efficiency by enabling the trained agent neural network to achieve higher performance with fewer environmental interactions (fewer training steps) compared to agent neural networks trained with manually designed rules. This reduction in required training steps directly translates to reduced consumption of computational resources (e.g., processor cycles and memory bandwidth) during the training of an agent neural network. As an example, a comparison of performance of the described techniques on the Atari benchmark (measured by a human-normalized Interquartile Mean or IQM) versus computational cost (measured in TPU hours) reveals that an agent trained with the described techniques achieves higher performance scores more rapidly than other techniques (e.g., MuZero algorithm). Specifically, data indicates that the described techniques reached the other technique's final performance level while requiring approximately 40% less computation (TPU-hours).

The described techniques also improve the field of machine learning, e.g., by enabling agent neural networks to perform machine learning tasks with higher accuracy and efficiency than is achievable with static, manually designed learning rules. As an example, on the Atari benchmark, which consists of 57 diverse game environments, the described techniques achieved a human-normalized Interquartile Mean (IQM) score of 13.86, surpassing the performance of all existing techniques evaluated on that benchmark.

The described techniques can train the target-generating neural network via meta-learning on a meta-learning objective, allowing for the discovery of complex update rules that are optimized for the specific capabilities of the agent and the dynamics of the environment.

By training the target-generating neural network through meta-learning on a meta-learning objective that measures a performance of a plurality of training agent neural networks in controlling respective training agents in respective training environments, the described techniques ensure the discovered learning rule (trained target-generating neural network) is robust and generalizable. This meta-learning on a meta-learning objective approach prevents overfitting the target-generating neural network to a single deterministic environment, thereby producing a trained target-generating neural network capable of being used to train agent neural networks to solve a diverse range of unseen tasks with high efficiency.

By configuring the target-generating input to not include the respective observation in the transition, the described techniques decouple the target-generating neural network from specific observation modalities (e.g., images) of the environment, which allows a single target-generating neural network to be trained on one set of environments and effectively train agent neural networks in completely different environments with different observation spaces without modification or retraining.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows a reinforcement learning system.

FIG. 2A is a flow diagram of an example process for training an agent neural network to control an agent in an environment to perform a task.

FIG. 2B shows an example target-generating neural network that processes a target-generating input to generate the target-generating output.

FIG. 2C shows an example recurrent neural network component of a target-generating neural network that processes a sequence of trajectories to update an inter-trajectory hidden state.

FIG. 3 is a flow diagram of an example process for training the target-generating neural network on the meta-learning objective.

FIG. 4 shows an example of performance of the described techniques.

FIG. 5 shows an example of performance of the described techniques.

FIG. 6 shows an example of performance of the described techniques.

Like reference numbers and designations in the various drawings indicate like elements.

### DETAILED DESCRIPTION OF THE DRAWINGS

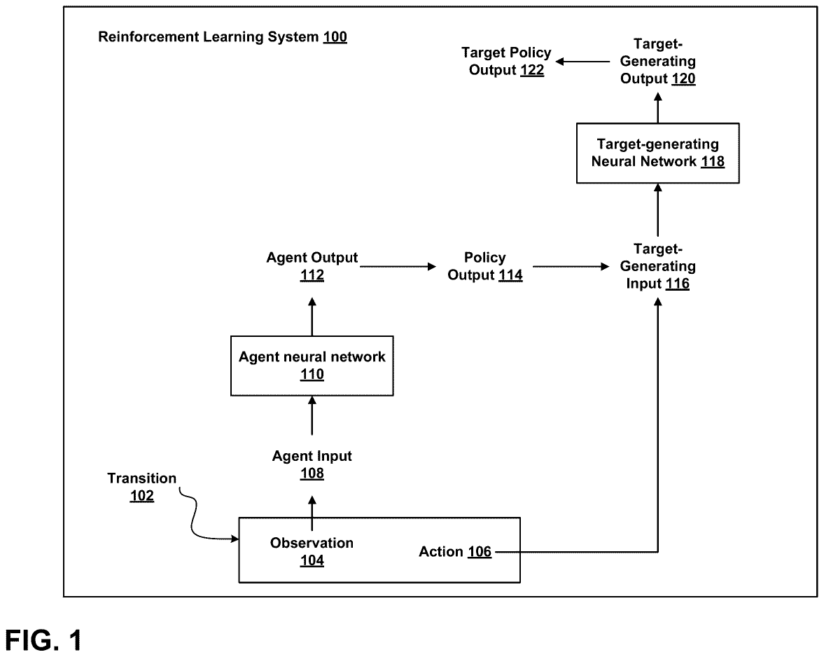

FIG. 1 shows an example reinforcement learning system 100. The system 100 is an example of a system implemented as computer programs on one or more computers in one or more locations, in which the systems, components, and techniques described below can be implemented.

This specification generally describes a reinforcement learning system 100 that trains an agent neural network 110 to control an agent interacting with an environment to perform a task.

In particular, the agent neural network 110 is configured to process an agent input that includes an observation characterizing a state of the environment to generate an agent output that includes a policy output that defines a respective score for each action in a set of actions that can be performed by the agent. For example, when the set of actions is discrete, the policy output can include a respective score, e.g., a respective logit score or probability, for each of the actions, i.e., it can define a categorical distribution. As another example, when the set of actions is continuous, the policy output can include parameters of a probability distribution over the set of actions.

When controlling the agent, the system 100 controls the agent to accomplish a task by selecting actions to be performed by the agent at each of multiple time steps during the performance of an episode of the task using policy outputs generated by the agent neural network 110.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation characterizing the current state of the environment at the time step and, in response, selects an action to be performed by the agent at the time step. After the agent performs the action, the environment transitions into a new state.

The observation can include any appropriate information that characterizes the state of the environment. As one example, the observation can include sensor readings from one or more sensors configured to sense the environment. For example, the observation can include one or more images captured by one or more cameras, measurements from one or more proprioceptive sensors, and so on. The environment can be a real-world environment and the camera or sensors can be cameras or sensors in the real-world environment; or the agent neural network can be in a simulation of this environment and afterwards used in the real-world environment to perform the task.

In some cases, the system 100 receives an extrinsic reward (also referred to as a “task” reward or just a “reward”) from the environment in response to the agent performing the action.

Generally, the reward is a scalar numerical value and characterizes a progress of the agent towards completing the task.

As a particular example, the reward can be a sparse binary reward that is zero unless the task is successfully completed and one if the task is successfully completed as a result of the action performed.

As another particular example, the reward can be a dense reward that measures a progress of the agent towards completing the task as of individual observations received during the episode of attempting to perform the task, i.e., so that non-zero rewards can be and frequently are received before the task is successfully completed.

In some cases, the reward can be generated by a reward model, such as based on the observation. As one example of this, the reward model may be learned using a success detector that detects successful behavior from observations of the environment, e.g., as described in “Vision-Language Models as Success Detectors” arXiv:2303.07280.

Generally, when controlling the agent, and at each time step, the system 100 receives an observation characterizing the state of the environment at the time step.

The system 100 uses the agent neural network 110 to generate a policy output by processing an agent input that includes the observation.

The system 100 then selects an action using the policy output, e.g., by selecting the action with the highest score or sampling an action in accordance with the policy output.

The agent input can also optionally include additional data in addition to the observation. For example, the system 100 can receive, e.g., from a user or from the environment, a natural language instruction or other communications specifying the task to be performed. In this example, the agent input can also include the most-recent communication. Other examples of information that can be included in the agent input include the most-recently performed action, the most-recently received reward, or both.

The system then causes the agent to perform the selected action.

As will be described below, during training, the agent neural network 110 can also generate one or more additional outputs as part of the agent output, e.g., one or more of a state-conditioned prediction vector, an action-conditioned prediction vector, or a state-action value estimate.

The agent neural network 110 can generally have any appropriate architecture. For example, the agent neural network 110 can include an encoder neural network that encodes the agent input and one or more prediction heads that generate the agent output. For example, the agent neural network can include a respective prediction for the policy output and for each additional output that the agent neural network generates.

To train the agent neural network 110, the system 100 repeatedly obtains trajectories that each include a respective sequence of transitions. For example, as training progresses, the system 100 can control the agent using the agent neural network 110 to generate trajectories and add the trajectories to a replay memory. The system 100 can then sample from the replay memory each time a trajectory is needed for training.

Any given training trajectory includes a sequence of transitions, with each transition 102 in the sequence including a respective observation 104 characterizing a state of an environment and an action 106 performed by an agent to perform a task in response to the respective observation.

To train on a training trajectory, for each transition 102 in the training trajectory, the system 100 processes an agent input 108 that includes the respective observation 104 in the trajectory using the agent neural network 110 to generate an agent output 112 that includes a policy output 114 that defines a respective score for each action in a set of actions. As described above, the agent output 112 can also include one or more other, additional outputs.

The system 100 processes a target-generating input 116 that includes the policy output 114 and the action 106 in the transition 102 using a target-generating neural network 118 to generate a target-generating output 120 that includes a target policy output 122. As will be described below, the target-generating output 120 can also include a respective target output for one or more of the additional output(s) generated by the agent neural network 110.

The system 100 trains the agent neural network 110 on a loss function that includes a policy loss that measures, for each transition 102, an error between the policy output for the transition 102 and the target policy output 122 for the transition 102 generated by the target-generating neural network 118.

In general, the system 100 trains the agent neural network 110 by adjusting the parameters of the agent neural network 110 to minimize the loss function. The system 100 calculates the loss function based on the discrepancy between the agent neural network's agent output (including the policy output) and the dynamic targets included in the target-generating output 120 generated by the target-generating neural network 118. The system 100 can then compute gradients of this loss function with respect to the agent neural network's 110 parameters and updates the parameters using an optimization algorithm (e.g., gradient descent) to reduce the error. By minimizing the policy loss, the agent neural network 110 learns to update its policy output 114 towards the target policy output 122.

The system 100 can train the target-generating neural network 118 through meta-learning on a meta-learning objective that measures a performance of a plurality of training agent neural networks 110 in controlling respective training agents in respective training environments. This training will be described in more detail below.

Thus, the system uses “targets” generated by the target-generating neural network 118 to train the agent neural network 110. The target-generating neural network 118 thus effectively represents a reinforcement learning “rule” that dynamically generates target outputs 120 for the training of the agent neural network 110 in order to maximize the effectiveness of the training of the agent neural network 110. Because the target-generating neural network 118 is trained through meta-learning, the targets 120 are guided by the cumulative experience of many generations of agents, resulting in high-quality targets 120 and, as a result, more effective training.

Some examples of the environment and the agent now follow.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the mechanical agent, e.g., robot, may be interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement e.g., braking and/or acceleration of the vehicle.

In some implementations the environment is a simulation of the above-described real-world environment, and the agent is implemented as one or more computers interacting with the simulated environment. For example, the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example, the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use of a resource the metric may comprise any metric of usage of the resource.

In general observations of a state of the environment may comprise any electronic signals representing the functioning of electronic and/or mechanical items of equipment. For example, a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment such as a heater, a cooler, a humidifier, or other hardware that modifies a property of air in the real-world environment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example, a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example, a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, or chemical synthesis steps, e.g., by controlling synthesis steps selected by the system automatically without human interaction. The observations may comprise direct or indirect observations of a state of the protein or chemical/intermediates/precursors and/or may be derived from simulation. Thus the system may be used to automatically synthesize a protein with a particular function such as having a binding site shape, e.g., a ligand that binds with sufficient affinity for a biological effect that it can be used as a drug. For example, e.g., it may be an agonist or antagonist of a receptor or enzyme; or it may be an antibody configured to bind to an antibody target such as a virus coat protein, or a protein expressed on a cancer cell, e.g., to act as an agonist for a particular receptor or to prevent binding of another ligand and hence prevent activation of a relevant biological pathway.

In a similar way the environment may be a drug design environment such that each state is a respective state of a potential pharmaceutically active compound, i.e., a drug, and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. The agent may be, or may include a mechanical agent that performs or controls synthesis of the pharmaceutically active compound; and hence a process as described herein may include making such a pharmaceutically active compound.

For example, the environment may be an in silico drug design environment, e.g., a molecular docking environment, and the agent may be a computer system for determining elements or a chemical structure of the drug. The drug may be a small molecule or biologic drug. An observation may be an observation of a simulated combination of the drug and a target of the drug. An action may be an action to modify the relative position, pose or conformation of the drug and drug target (or this may be performed automatically) and/or an action to modify a chemical composition of the drug and/or to select a candidate drug from a library of candidates. One or more rewards may be defined based on one or more of: a measure of an interaction between the drug and the drug target, e.g., of a fit or binding between the drug and the drug target; an estimated potency of the drug; an estimated selectivity of the drug; an estimated toxicity of the drug; an estimated pharmacokinetic characteristic of the drug; an estimated bioavailability of the drug; an estimated ease of synthesis of the drug; and one or more fundamental chemical properties of the drug. A measure of interaction between the drug and drug target may depend on, e.g., a protein-ligand bonding, van der Waal interactions, electrostatic interactions, and/or a contact surface region or energy; it may comprise, e.g., a docking score. Following identification of elements or a chemical structure of a drug in simulation, the method may further comprise making the drug. The drug may be made partly or completely by an automatic chemical synthesis system.

In some applications the agent may be a software agent i.e., a computer program, configured to perform a task. For example, the environment may be a circuit or an integrated circuit design or routing environment and the agent may be configured to perform a design or routing task for routing interconnection lines of a circuit or of an integrated circuit, e.g., an ASIC. The reward(s) may then be dependent on one or more routing metrics such as interconnect length, resistance, capacitance, impedance, loss, speed or propagation delay; and/or physical line parameters such as width, thickness or geometry, and design rules. The reward(s) may also or instead include one or more reward(s) relating to a global property of the routed circuitry, e.g., component density, operating speed, power consumption, material usage, a cooling requirement, level of electromagnetic emissions, and so forth. The observations may be, e.g., observations of component positions and interconnections; the actions may comprise component placing actions, e.g., to define a component position or orientation and/or interconnect routing actions, e.g., interconnect selection and/or placement actions. The task may be, e.g., to optimize circuit operation to reduce electrical losses, local or external interference, or heat generation, or to increase operating speed, or to minimize or optimize usage of available circuit area. The method may include making the circuit or integrated circuit to the design, or with interconnection lines routed as determined by the method.

In some implementations, the environment is a chip design environment. The task is to generate a chip design for a computer chip that satisfies an input specification. The input specification may define requirements regarding area, power consumption, timing, or thermal constraints. In these implementations, the state of the environment corresponds to a respective state of the chip design. The actions correspond to chip design decisions.

In some applications the agent is a software agent and the environment is a real-world computing environment. In one example the agent manages distribution of tasks across computing resources, e.g., on a mobile device and/or in a data center. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

In another example the software agent manages the processing, e.g., by one or more real-world servers, of a queue of continuously arriving jobs. The observations may comprise observations of the times of departures of successive jobs, or the time intervals between the departures of successive jobs, or the time a server takes to process each job, e.g., the start and end of a range of times, or the arrival times, or time intervals between the arrivals, of successive jobs, or data characterizing the type of job(s). The actions may comprise actions that allocate particular jobs to particular computing resources; the reward(s) may be configured to minimize an overall queueing or processing time or the queueing or processing time for one or more individual jobs, or in general to optimize any metric based on the observations.

As another example the environment may comprise a real-world computer system or network, the observations may comprise any observations characterizing operation of the computer system or network, the actions performed by the software agent may comprise actions to control the operation, e.g., to limit or correct abnormal or undesired operation, e.g., because of the presence of a virus or other security breach, and the reward(s) may comprise any metric(s) that characterizing desired operation of the computer system or network.

In some applications, the environment is a real-world computing environment and the software agent manages distribution of tasks/jobs across computing resources, e.g., on a mobile device and/or in a data center. In these implementations, the observations may comprise observations that relate to the operation of the computing resources in processing the tasks/jobs, the actions may include assigning tasks/jobs to particular computing resources, and the reward(s) may relate to one or more metrics of processing the tasks/jobs using the computing resources, e.g., metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise, e.g., observations of a routing table which includes routing metrics such as a metric of routing path length, bandwidth, load, hop count, path cost, delay, maximum transmission unit (MTU), and reliability. The reward(s) may be defined in relation to one or more of the routing metrics, i.e., configured to maximize one or more of the routing metrics.

In some other applications the environment is an Internet or mobile communications environment and the agent is a software agent which manages a personalized recommendation for a user. The observations may comprise previous actions taken by the user, e.g., features characterizing these; the actions may include actions recommending items such as content items to a user. The reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus the design of an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example, the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the agent neural network to be trained and evaluated on situations that occur rarely or are difficult or unsafe to re-create in the real-world environment. For example, the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations the observations are observations of a real-world environment in which a human is performing a task, e.g., an image observation from an image sensor and/or a language observation from a speech recognition system; and the actions are language actions that control (instruct) the human, e.g., using natural language or images, to perform actions in the real-world environment to perform the task. A language action may be an action that outputs a natural language sentence, e.g., by defining a sequence of language tokens, e.g., words or wordpieces, to be emitted at sequential time steps.

Thus the agent may comprise a user interface device such as a digital device (a “digital assistant”), e.g., a smart speaker or smart display or other device, e.g., with a natural language input and/or output, that controls (instructs) a human user to perform a task. In general such a digital device can be a mobile device with a natural language interface to receive natural language requests from a human user and to provide natural language responses. It may also include a vision based input, e.g., a camera and/or display screen. The digital device may include a language model or language generation neural network system either stored locally, or accessed remotely, or both. The user interface device may comprise, e.g., a mobile device, a keyboard (and optionally display), or a speech-based input mechanism, e.g., to input audio data characterizing a speech waveform of speech representing the input from the user in the natural or computer language and to convert the audio data into tokens representing the speech in the natural or computer language, i.e., representing a transcription of the spoken input. The user interface can also include a text or speech-based output, e.g., a display and/or a text-to-speech subsystem.

Thus in implementations the agent actions contribute to performing the task. A monitoring system, e.g., a video camera system, may be provided for monitoring the action (if any) which the user actually performs at each time step in case, e.g., due to human error, it is different from the action which the reinforcement learning system instructed the user to perform. The monitoring system can be used to determine whether the task has been completed. Training data may be collected by record the actions which the user actually performed based on the instruction. The reward value of an action may be generated, for example, by comparing the action the user took with a corpus of data showing a human expert performing the task, e.g., using techniques known from imitation learning, or in some other way, e.g., using a trained reward model. A system of this type can learn how to guide a human to perform a task, e.g., avoiding difficult to perform actions.

In some implementations, the environment is a data item compression environment and the agent is configured to perform a task to compress an input data item. The input data item may include, for example, an image, a video, an audio file, or a text document. In these implementations, each state of the environment corresponds to a respective state of the compression of the input data item. The actions correspond to encoding decisions made by the agent during the compression of the input data item.

In some implementations, the environment is an algorithm optimization environment. The task is to generate a computer program that optimizes a target algorithm for execution on a target processor. For example, the agent may generate assembly code or intermediate representation (IR) code that implements a specific mathematical function (the target algorithm) more efficiently than a baseline compiler. In these implementations, each state of the environment corresponds to a respective state of the generation of the computer program. The actions each apply a respective modification to the computer program.

In some implementations, the environment is an algorithm optimization environment where the mathematical structure of an algorithm is represented as a tensor. The task is to generate a sequence of modifications to a tensor that represent an algorithm that optimizes a target algorithm. In these implementations, each state of the environment corresponds to a respective state of the tensor. The actions each apply a respective modification to the tensor.

In some implementations, the environment is a computer system that includes a plurality of computing devices, such as a server farm, a cloud computing cluster, or a multi-core processor system. The task is to allocate one or more computational workloads across the plurality of computing devices. In these implementations, each state of the environment corresponds to a respective state of the computer system given a current allocation of the one or more computational workloads. For example, the state may characterize the current CPU or memory utilization of each computing device. The actions each apply a respective modification to the current allocation.

In some implementations, the environment is a video game environment and the agent is a software agent in the video game. For example, the video game environment may be a two-dimensional (2D) or three-dimensional (3D) simulation, such as a platformer, a first-person shooter, a strategy game, or a racing game.

Optionally, in any of the above implementations, the observation at any given time step may include data from a previous time step that may be beneficial in characterizing the environment, e.g., the action performed at the previous time step, the reward received at the previous time step, or both.

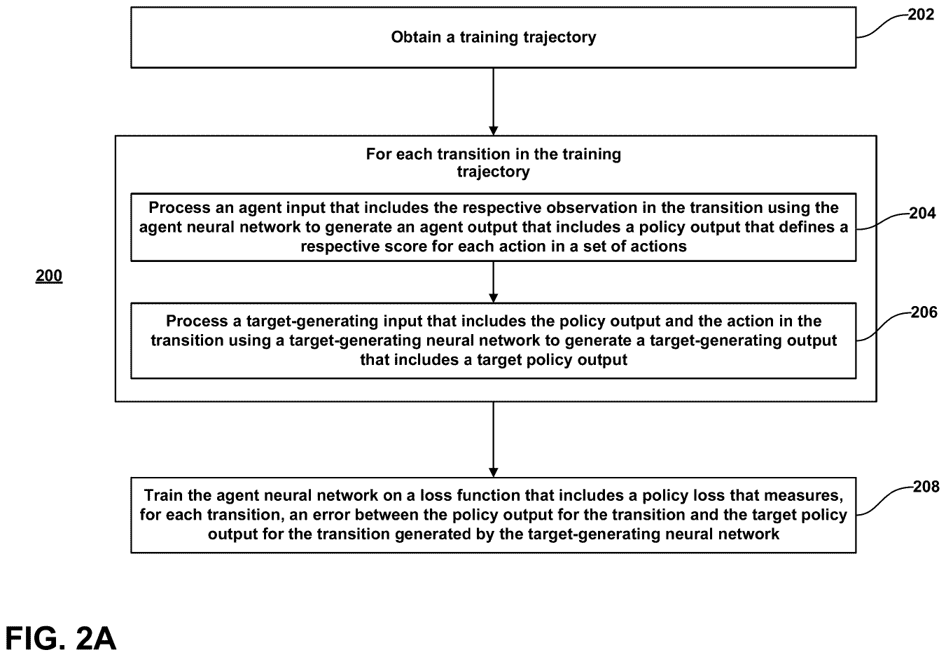

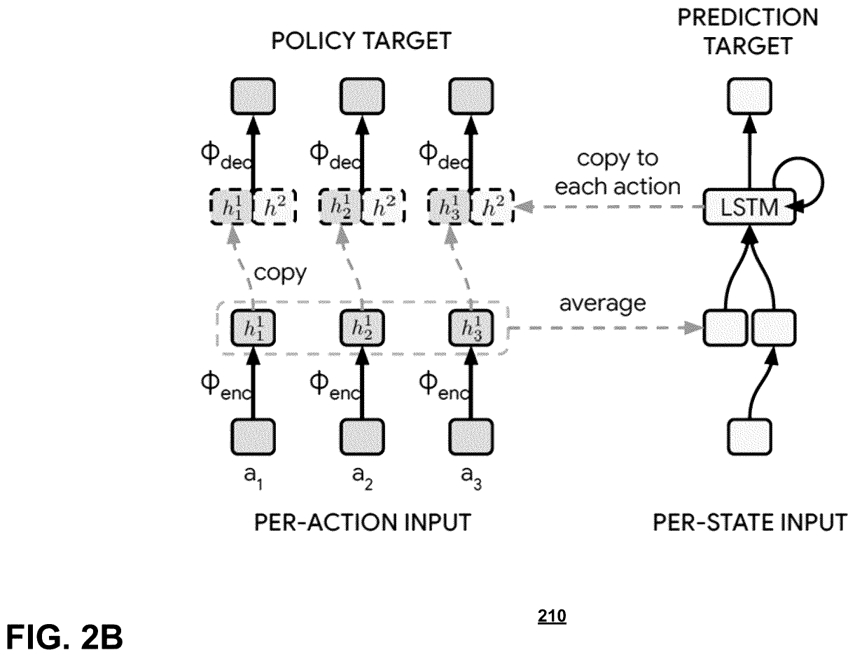

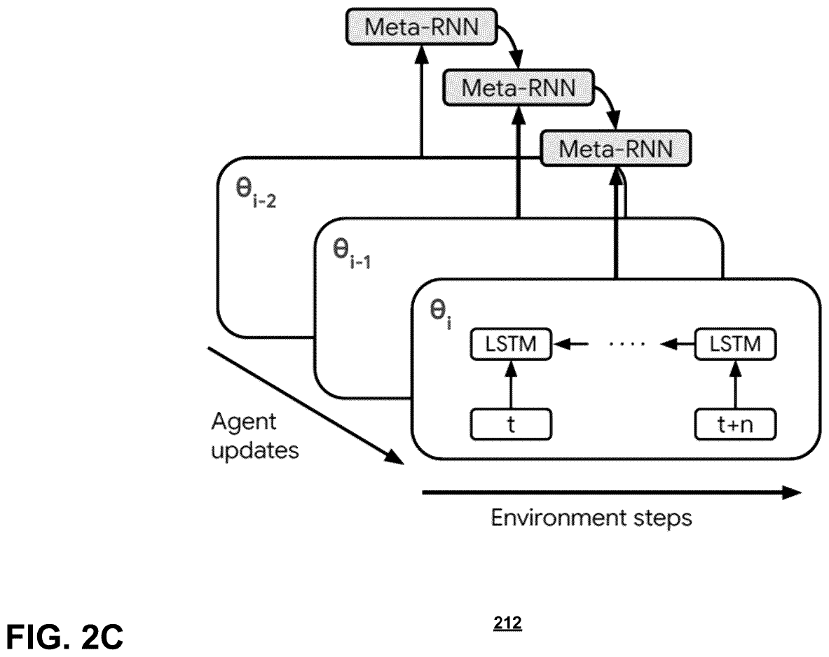

FIG. 2A is a flow diagram of an example process 200 for training an agent neural network to control an agent in an environment to perform a task. For convenience, the process 200 will be described as being performed by a system of one or more computers located in one or more locations. For example, a reinforcement learning system, e.g., the reinforcement learning system 100 of FIG. 1, appropriately programmed in accordance with this specification, can perform the process 200.

As described above, the agent, the environment, and the task can be any appropriate agent, environment, and task. The system is generally applicable to any setting in which the system controls an agent interacting with an environment to perform a task. In such settings, the system receives observations characterizing a state of the environment and processes the observations using the agent neural network to generate policy outputs. The system then controls the agent to perform actions selected based on the policy outputs to interact with the environment to perform a task, achieve a goal, or maximize a cumulative reward. The system can also utilize the same target-generating neural network to generate targets for training multiple different agents operating in multiple different environments.

As an example, the agent can be a mechanical agent such as a robot, and the environment can be a real-world environment such as a service facility or manufacturing environment. The agent can also be a software agent, such as a software agent in a real-world computing environment, or a software agent in a simulated environment, such as a video game. In general, the agent interacts with the environment to perform the task, which may be any of the tasks described above, such as controlling a robot to manipulate an object, controlling a service facility to minimize resource usage, or controlling a computing system to distribute workloads.

The system obtains a training trajectory (Operation 202). The training trajectory includes a sequence of transitions. Each transition in the sequence includes a respective observation characterizing a state of the environment and an action performed by the agent in response to the respective observation.

For example, in the context of the Atari benchmark, the environment is a video game, and the agent is a software agent interacting with the video game. In this example, the training trajectory corresponds to a sequence of game video frames (observations) received by the system and game controller inputs (actions) performed by the agent under the control of the system during a game episode. A transition includes the game video frame at time t and the action performed by the agent at time t. The trajectory is a collection of these transitions from the start of the game until the game ends, a timeout is reached, or another condition ending is met.

In some cases, transitions are arranged within the sequence according to a respective time step for each transition, and the transition in the sequence is a transition with a latest time step. For example, the system can obtain a trajectory with a sequence of transitions in reverse chronological order, starting from the end of the episode (time t+n) and moving backwards to an earlier time step (time t).

The system can obtain the training trajectory from any appropriate source, e.g., system maintained memory or another system.

In some implementations, the system obtains the training trajectory by controlling the agent using the agent neural network to interact with the environment. For example, the system can control the agent based the policy output defined by the agent neural network to select actions in response to observations, thereby generating the sequence of transitions.

In some implementations, the system obtains the training trajectory by sampling from a replay memory. As the agent interacts with the environment, the system stores the resulting sequences of transitions in a replay memory (or experience replay buffer). When the system requires a training trajectory for Operation 202, the system samples a previously stored trajectory from this replay memory.

Each transition in the obtained training trajectory can further include a respective reward received by the agent from the environment in response to performing the action. The training trajectory can also include data indicating whether a specific transition corresponds to a termination of the task.

For example, in a video game environment, the respective reward may be a scalar value representing points scored by the agent (e.g., +10 or −1), and the data indicating termination may be a binary indicator (e.g., 0 or 1) that signals whether the game episode has ended, such as when the agent fails a level or completes a level.

For each transition in the training trajectory, the system performs Operations 204 and 206 below.

The system processes an agent input that includes the respective observation in the transition using the agent neural network to generate an agent output that includes a policy output that defines a respective score for each action in a set of actions (Operation 204).

The agent neural network can have any of a variety of neural network architectures. That is, the agent neural network can have any appropriate architecture in any appropriate configuration that can process an agent input that includes the respective observation in the transition to generate an agent output that includes a policy output that defines a respective score for each action in a set of actions. The architecture can include, e.g., fully connected layers, convolutional layers, recurrent layers, attention-based layers, and so on, as is appropriate.

In some cases, the agent neural network includes an encoder configured to encode the agent input to generate an encoded representation and includes one or more neural network heads that are configured to process the encoded representation to generate the agent output. For example, the encoder can include a convolutional neural network (CNN) or a Residual Network (ResNet) that processes an image observation into a compact feature embedding, and the neural network heads can include a respective multi-layer perceptron (MLP) for each component of the agent output, such as a policy head that maps the embedding to a policy output.

In some cases, the agent output further includes a state-conditional prediction vector (y). The state-conditional prediction vector can be a latent vector in a first latent space. That is, the state-conditional prediction vector can be a vector of values of an arbitrary size that does not necessarily have a pre-defined semantic meaning. The state-conditional prediction vector (y) is generated by the agent neural network based on the observation(s) of the transition currently being processed.

In some cases, the agent output further includes a respective action-conditional prediction vector (z) for each of at least a subset of the actions. Each action-conditional prediction vector can be a latent vector in a second latent space. Similar to the state-conditional prediction vector, the action-conditional prediction vectors may be vectors of values of an arbitrary size that do not necessarily have pre-defined semantic meanings. Each action-conditional prediction vector is generated by the agent neural network based on both the observation(s) of the transition currently being processed and a respective action in the set of actions.

In some cases, the agent output further includes a respective action-value estimate for each of at least a subset of the actions. For example, the agent neural network can output a vector of action-values that each represent an estimate of the expected cumulative future reward the agent will receive if it performs the specific corresponding action in response to the current observation.

In some cases, the agent output further includes an auxiliary policy prediction (p). The auxiliary policy prediction can represent a prediction of the agent's policy output at a future state, for example, a one-step future state, i.e., at a state that is one time step in the future relative to the current time step.

The system processes a target-generating input that includes the policy output and the action in the transition using a target-generating neural network to generate a target-generating output that includes a target policy output (operation 206).

In some cases, the target-generating input does not include the respective observation in the transition. By excluding the observation (e.g., pixel data from a game video frame or sensor readings from a robot), the target-generating input is decoupled from the specific sensory modalities and dimensionality of the environment.

In some cases, when each transition further includes a respective reward received in response to the agent performing the action in the transition, the target-generating input further includes the respective reward.

Moreover, in some cases, when the agent output also includes additional predictions, the target-generating input can also include some or all of the additional predictions. Some examples of this follow.

In some cases, when the agent output further includes a state-conditional prediction vector, the target-generating input further includes the state-conditional prediction vector, and the target-generating output further includes a target state-conditional prediction vector.

In some cases, when the agent output further includes a respective action-conditional prediction vector for each of at least a subset of the actions, the target-generating input further includes the respective action-conditional prediction vectors, and the target-generating output further includes a respective target action-conditional prediction vector for each of at least the subset of the actions.

In some cases, when the agent output further includes a respective action-value estimate for each of at least a subset of the actions, the target-generating input further includes the respective action-value estimates.

In some implementations, the target-generating input further includes an indicator variable that indicates whether the transition was a terminal transition in a task episode. A terminal transition in a task episode is a transition after which the agent's interaction with the environment for that specific attempt concludes, either due to success, failure, a time constraint, or any other event that signifies an end of an episode. For example, in the context of the Atari game environment, the indicator variable can be a binary value or a float, such as 1.0, indicating that the game has ended or 0.0 indicating that the episode is continuing.

The target-generating neural network can have any of a variety of neural network architectures. That is, the target-generating neural network can have any appropriate architecture in any appropriate configuration that can process a target-generating input that includes the policy output and the action in the transition to generate a target-generating output that includes a target policy output. The architecture can include, e.g., fully connected layers, convolutional layers, recurrent layers, attention-based layers, and so on, as is appropriate.

In some implementations, the target-generating neural network is configured to, prior to processing a first transition in the sequence, initialize a trajectory-internal hidden state of the target-generating neural network. For each transition, the target-generating neural network processes the target-generating input for the transition to update the trajectory-internal hidden state of the target-generating neural network. After updating the trajectory-internal hidden state, the target-generating neural network processes a decoder input that includes the trajectory-internal hidden state using one or more decoder neural network heads to generate the target-generating output.

FIG. 2B shows an example 210 target-generating neural network that processes a target-generating input to generate the target-generating output. The target-generating input includes per-action inputs (e.g., action-conditional prediction vectors corresponding to actions a₁, a₂, a₃) and per-state inputs (e.g., state-conditional prediction vectors, rewards, or termination signals). The per-action inputs are processed by an encoder φ_{enc} to generate respective action-specific embeddings (h¹). The weights of the encoder φ_{enc} are shared across the action dimension, allowing the target-generating neural network to process an arbitrary number of actions. The action-specific embeddings are aggregated, for example by computing an average, to generate an action-invariant embedding. This action-invariant embedding is combined with the per-state input and processed by a sequence-processing neural network component to update a trajectory-internal hidden state (h²) (a first hidden state). While depicted as a recurrent neural network (e.g., Long Short-Term Memory (LSTM) network) component in this example, in some other cases, this component can utilize any neural network architecture capable of processing sequential data. For example, the sequence-processing neural network can include self-attention layers (e.g., a Transformer architecture with self-attention layers), a Gated Recurrent Unit (GRU) network, Convolutional Neural Network (CNN), or a temporal convolutional network (TCN). The updated trajectory-internal hidden state (h²) serves as a temporal context vector that encodes future trajectory information. This updated hidden state is utilized to generate the target-generating output via separate decoding heads. Specifically, to generate the policy target, the trajectory-internal hidden state (h²) is concatenated with each of the action-specific embeddings (h¹) and processed by a policy decoder head dec (which also shares weights across actions) to produce a target value for each action. Additionally, the trajectory-internal hidden state (h²) is processed by a respective decoder head to generate prediction targets (e.g., targets for the state-conditional or action-conditional predictions).

In some implementations, the target-generating neural network is configured to, prior to training the agent neural network, initialize an inter-trajectory hidden state of the target-generating neural network (a second hidden state), and for each trajectory in the sequence, process the transitions in the trajectory to update the inter-trajectory hidden state. Unlike the trajectory-internal hidden state, which resets for each training trajectory, the inter-trajectory hidden state persists across the sequence of trajectories to capture learning dynamics of the agent neural network over the agent neural network's lifetime (e.g., across multiple training trajectories). For example this can facilitate learning to use techniques similar to reward normalization. In these implementations, the system trains the agent neural network on a sequence of trajectories that includes the trajectory.

In some cases, the decoder input that includes the trajectory-internal hidden state processed using one or more decoder neural network heads further includes the inter-trajectory hidden state after the target-generating neural network updated the inter-trajectory hidden state for a preceding trajectory in the sequence. By combining these states, the target-generating neural network generates targets that are conditioned not only on the immediate context of the current trajectory (via the trajectory-internal state) but also on the agent neural network's long-term training progress (via the inter-trajectory state).

In some implementations, the target-generating neural network processes the transitions in the trajectory to update the inter-trajectory hidden state by processing the transitions in the trajectory using an embedding neural network to generate an embedding of the trajectory. Then, the target-generating neural network processes the embedding of the trajectory and the inter-trajectory hidden state using a recurrent neural network to update the inter-trajectory hidden state.

FIG. 2C shows an example recurrent neural network component 212 of a target-generating neural network that processes a sequence of trajectories to update an inter-trajectory hidden state. The component, which is referred to as “Meta-RNN” in example 212, processes a sequence of trajectories generated during successive agent neural network updates (e.g., updates corresponding to agent neural network parameters θᵢ₋₂, θᵢ₋₁, θᵢ).

For each agent neural network update, represented in FIG. 2C by a respective rounded rectangle labeled with the corresponding agent parameters (e.g., θᵢ), the transitions within the corresponding trajectory are processed to generate a trajectory embedding. For example, to handle high-dimensional observations within the transitions (e.g., sequences of images or video frames), the system can first process the observations using an encoder, such as a Convolutional Neural Network (CNN) or a Vision Transformer (ViT), to generate compact feature representations. The system then processes these representations using the recurrent neural network component 212, for example, a sequence-processing neural network (e.g., an LSTM processing transitions from t to t+n) to generate the trajectory embedding.

The recurrent neural network component 212 (i.e., “Meta-RNN”) processes the trajectory embedding to update the inter-trajectory hidden state. While the recurrent neural network component 212 is described as a recurrent neural network or “Meta-RNN” for this example, this component can utilize any neural network architecture capable of processing sequential data and maintaining a hidden state or memory context. For example, the component 212 can include self-attention layers (e.g., transformer architecture with self-attention mechanisms), a Gated Recurrent Unit (GRU), a Convolutional Neural Network (CNN), or a temporal convolutional network (TCN). The system carries forward the updated inter-trajectory hidden state to the next agent neural network update step and can use the updated inter-trajectory hidden state as an additional input to the decoder heads of the target-generating neural network to condition the generation of targets on the agent neural network's long-term learning progress.

The system trains the agent neural network on a loss function that includes a policy loss that measures, for each transition, an error between the policy output for the transition and the target policy output for the transition generated by the target-generating neural network (Operation 208).

For example, to train the agent neural network, the system can compute gradients of the loss function with respect to the parameters (e.g., weights and biases) of the agent neural network using backpropagation. The system then updates the parameters of the agent neural network based on these computed gradients using an optimization algorithm, such as stochastic gradient descent (SGD) or Adam.

The policy loss, for example, can be calculated by the system based on a distance metric, such as a Kullback-Leibler (KL) divergence, between the policy output and the target policy output. The policy loss can be expressed as D(\hat{π}, π_{θ}(s)), where D represents the distance metric, \hat{π} represents the target policy output generated by the target-generating neural network, and π_{θ}(s) represents the policy output generated by the agent neural network with parameters θ for a given observation s.

The loss function can be a composite loss function that aggregates multiple loss terms. For example, the loss function can be a weighted sum of the policy loss and any additional prediction losses (described below).

In some implementations, the loss function further includes a state-condition prediction loss that measures, for each transition, an error between the state-conditional prediction vector for the transition and the target state-conditional prediction vector for the transition generated by the target-generating neural network.

For example, the state-condition prediction loss can be expressed as D(ŷ, y_{θ}(s)), where D represents a distance function (e.g., KL divergence), ŷ represents the target state-conditional prediction vector generated by the target-generating neural network, and y_{θ}(s) represents the state-conditional prediction vector generated by the agent neural network for the observation s.

By including the state-conditional prediction vector in the agent output and including the state-condition prediction loss in the loss function, the system enables the agent neural network to learn rich internal representations of the observation that capture task-relevant information (e.g., salient events or future values) beyond what is required for generating the policy output, thereby regularizing the training of the agent neural network and improving its convergence.

In some implementations, the loss function further includes an action-condition prediction loss that measures, for each transition and for each of at least the subset of the actions, an error between the respective action-conditional prediction vector for the action and the respective target action-conditional prediction vector for the action generated by the target-generating neural network.

For example, the action-condition prediction loss can be expressed as D(\hat{z}, z_{θ}(s, a)), where \hat{z} represents the target action-conditional prediction vector generated by the target-generating neural network, z_{θ}(s, a) represents the action-conditional prediction vector generated by the agent neural network for the observations and the action a, and D represents the distance function (e.g., KL divergence).

By including these action-conditional prediction vectors in the agent output and including the action-condition prediction loss in the loss function, the system enables the agent neural network to learn semantics specific to the dynamics or value of taking particular actions, enabling the discovery of complex relationships between actions and future outcomes, which regularizes the training of the agent neural network and improves its convergence.

In some implementations, the loss function further includes an action-value estimate loss that measures, for each transition, an error between the respective action-value estimates for the actions for the transition and a temporal-difference target for the transition.

For example, the action-value estimate loss can be included as an auxiliary loss. For example, the auxiliary loss can be expressed as D(\hat{q}, q_{θ}(s, a)), where \hat{q} represents the temporal-difference target (e.g., an action-value target calculated using the Retrace algorithm, as described in arXiv:1606.02647, and optionally projected onto a two-hot vector) and q_{θ}(s, a) represents the action-value estimate generated by the agent neural network for the observation s and action.

As an example loss function L(θ) that aggregates multiple loss terms, the loss function can be

$$L ( θ ) = {E}_{s , a ∼ {π}_{θ}} [ D ( \hat{π} , {π}_{θ} ( s ) ) + D ( \hat{y} , {y}_{θ} ( s ) ) + D ( \hat{z} , {z}_{θ} ( s , a ) ) + {L}_{aux} ]$$

where the expression includes an expectation over observations s and actions a sampled from the policy output π_{θ} of the agent neural network throughout a trajectory and θ represents parameters of the agent neural network. In this expression, D(p, q) represents a distance function between two probability distributions p and q, such as the Kullback-Leibler (KL) divergence. The specific terms within the example loss function above correspond to distinct loss terms that respectively correspond to distinct learning objectives. The policy loss term D(\hat{π}, π_{θ}(s)) measures the error between the policy output π_{θ}(s) of the agent neural network (optionally using an exponential moving average of the parameters θ rather than using the parameters themselves) and the target policy output \hat{π} generated by the target-generating neural network. Additionally, the state-condition prediction loss term D(ŷ, y_{θ}(s)) measures the error between the state-conditional prediction vector y_{θ}(s) of the agent neural network and the corresponding target state-conditional prediction vector ŷ generated by the target-generating neural network. Similarly, the action-condition prediction loss term D(\hat{z}, z_{θ}(s, a)) measures the error between the action-conditional prediction vector z_{θ}(s, a) of the agent neural network and the corresponding target action-conditional prediction vector 2 generated by the target-generating neural network. The loss function also includes an auxiliary loss term Lₐᵤₓ that measures errors for predictions with pre-defined semantics, such as action-value estimates (q) and auxiliary policy predictions (p). For example, the auxiliary loss can be defined as Lₐᵤₓ=D(\hat{q}, q_{θ}(s, a))+D(\hat{p}, p_{θ}(s, a)), where \hat{q} represents a temporal-difference target, such as a target derived from Retrace, and \hat{p} represents the policy at the next time step. By minimizing this composite loss function, the system effectively updates the parameters θ of the agent neural network to align its policy output and other predictions with the dynamic targets provided by the target-generating neural network and the auxiliary objectives.

The example process 200 can be repeatedly performed to iteratively train the agent neural network. For example, after updating the agent neural network's parameters in Operation 208, the system can obtain a new training trajectory (Operation 202) using the updated agent neural network (e.g., either through fresh interaction with the environment or by sampling new data from the replay memory). The system then repeats Operations 204, 206, and 208 for the transitions in the new trajectory. This cycle can continue for a predetermined number of training steps or until the agent neural network achieves a desired level of performance on the task. Throughout this iterative process, the target-generating neural network, which remains fixed (frozen) during the training of a specific agent neural network for a specific task, provides dynamic targets tailored to the evolving capabilities of the agent neural network.

In some implementations, the target-generating neural network has been trained through meta-learning on a meta-learning objective that measures a performance of a plurality of training agent neural networks in controlling respective training agents in respective training environments. Such meta-learning can involve determining a meta-gradient by differentiating the meta-learning objective (e.g., the expected cumulative reward) with respect to parameters, e.g., weights, of the target-generating neural network. The meta-gradient can be backpropagated through a sequence of parameter updates of the agent neural network, to optimize the parameters, of the target-generating neural network, using any suitable optimizer, e.g., Adam.

For example, the system can have trained the target-generating neural network by performing a meta-optimization procedure (i.e., meta-learning on a meta-learning objective). In this procedure, the system instantiates a population of training agents. Each training agent is controlled by a respective training agent neural network and interacts with a respective training environment. The system trains the target-generating neural network to maximize a meta-learning objective, denoted as J(η), where η represents the parameters of the target-generating neural network. The meta-learning objective measures the expected performance of the training agents. For example, the meta-learning objective can be expressed as:

$$J ( η ) = {E}_{ϵ} {E}_{θ} [ J ( θ ) ]$$

where ϵ represents a training environment sampled from a distribution, θ represents the parameters of a training agent neural network induced by the target-generating neural network, and J(θ) represents the expected return of the agent. The expected return J(θ) may be defined as an expected time-discounted sum of rewards received by the agent controlled by one of the plurality of training agent neural networks, expressed as:

$$J ( θ ) = E [ {\sum }_{t} {γ}^{t} {r}_{t} ]$$

where γ is a discount factor and rₜ is the reward at time step t. The system updates the parameters η of the target-generating neural network based on a meta-gradient calculation. This calculation estimates how changes in the parameters of the target-generating neural network affect the cumulative rewards achieved by the training agents. For example, the system may compute an estimate of the meta-gradient ∇_{η}J(η). This calculation can involve backpropagating gradients through the sequence of updates performed by the training agent neural networks to determine how to adjust the target-generating neural network.

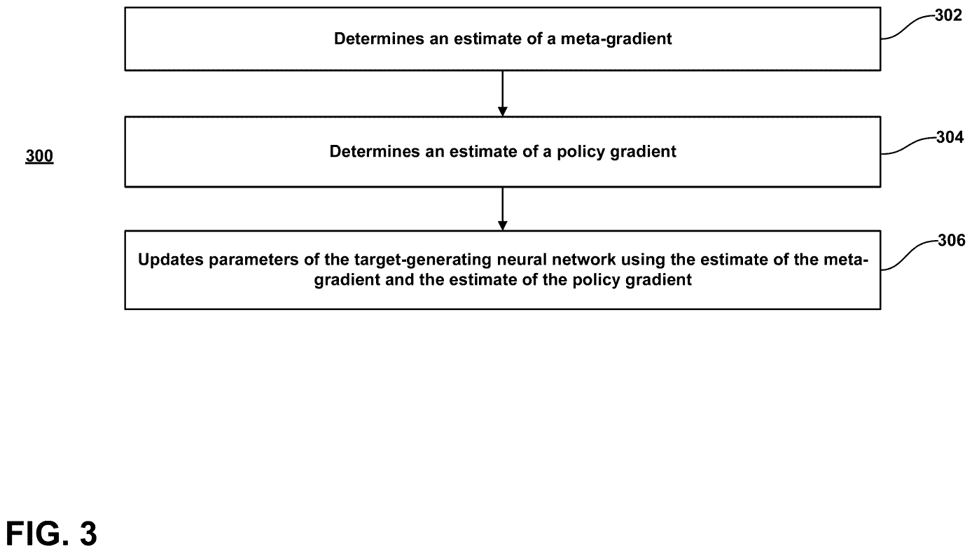

Further details of training the target-generating neural network on the meta-learning objective are described below with reference to FIG. 3.

In some cases, the agent neural network has more parameters than the training agent neural networks. For example, the training agent neural networks used during the meta-learning process can be smaller neural networks to allow for training, while the final agent neural network trained using the trained target-generating neural network can be a larger network to maximize its performance.

In some cases, the agent neural network has a different architecture than the training agent neural networks. For example, the training agent neural networks can include architectures configured for computational efficiency during the meta-learning process (e.g., a shallow convolutional neural network or a small feed-forward network), whereas the agent neural network may utilize a different architecture configured for maximum performance or capacity (e.g., a deep Residual Network, a Transformer, or a recurrent architecture including a Long Short-Term Memory layer) to handle complex task dynamics or significant temporal dependencies.

In some cases, two or more of the respective training agent neural networks are different from one another. For example, the training agents can include instances of with different parameters, even if they share the same neural network underlying architecture. As another example, the training agent neural networks can include training agent neural networks with different neural network architectures.

In some cases, two or more of the respective training environments are different from one another. For example, the set of training environments can include a diverse mix of games from the Atari benchmark (e.g., Ms PacMan and Breakout). As another example, one training environment can be a simulated warehouse environment wherein the task is to control a robotic manipulator to grasp and sort objects, while another training environment can be a simulated outdoor terrain environment wherein the task is to control a legged robot to navigate through obstacles to reach a target destination.

FIG. 3 is a flow diagram of an example process 300 for training the target-generating neural network on the meta-learning objective. For convenience, the process 300 will be described as being performed by a system of one or more computers located in one or more locations. For example, a reinforcement learning system, e.g., the reinforcement learning system 100 of FIG. 1, appropriately programmed in accordance with this specification, can perform the process 300.

As described above, the target-generating neural network is trained to optimize a meta-learning objective, denoted as J(η). The meta-learning objective measures the expected performance of the training agents. For example, the meta-learning objective can be expressed as:

$$J ( η ) = {E}_{ϵ} {E}_{θ} [ J ( θ ) ]$$

In this expression, η represents the parameters of the target-generating neural network, ϵ represents a training environment sampled from a distribution, θ represents the parameters of a training agent neural network induced by the target-generating neural network (e.g., through the history of updates determined by the target-generating neural network), and J(θ) represents the expected return of the agent (e.g., the expected time-discounted sum of rewards).

The system determines an estimate of a meta-gradient (operation 302).

The meta-gradient is the gradient of the meta-learning objective with respect to the parameters of the target-generating neural network (e.g., ∇_{η}J(η), where ∇_{η} denotes the gradient operator with respect to the parameters n). It indicates the direction in which the parameters of the target-generating neural network should be adjusted to improve the performance of the training agents.

In some implementations, to determine an estimate of the estimate of the meta-gradient, the system instantiates a population of training agents that are each controlled by a respective training agent neural network. The system trains each of the training agent neural networks using the target-generating neural network. Then, the system backpropagates through the training of each of the training agent neural networks to generate the estimate of the meta-gradient.

For example, to ensure the meta-gradient approximation reflects a true distribution of interest, the system may utilize a large number of complex and diverse environments that have varying reward sparsity or task horizons. The system can differentiate through the entire update procedure of the training agent neural networks across these diverse environments to calculate a gradient term ∇_{η}, which represents the sensitivity of the training agent neural network's parameters θ to changes in the target-generating neural network's parameters η. To make this computation tractable, the system can, in some cases, backpropagate over a limited window of agent neural network updates (e.g., 20 updates).

The system determines an estimate of a policy gradient (operation 304).

In some implementations, to determine an estimate of a policy gradient, the system determines the estimate of the policy gradient using an actor-critic reinforcement learning technique.

For example, the system can estimate the gradient of a standard reinforcement learning objective with respect to the agent parameters, denoted as ∇_{η}J(θ). The system can compute this estimate, for example, using the advantage actor-critic (A2C) method (e.g., as. To perform this calculation, the system may optionally train a “meta-value function” (distinct from the agent's action-value function) to estimate the value of observations for the current agent (e.g., trained based on an error between a predicted value and an actual value based on rewards received by the agent from the environment). The system can calculate a normalized advantage Ā based on the rewards received and the values predicted by the meta-value function. The system can then uses this advantage to estimate the gradient ∇_{η}J(θ).

The system updates parameters of the target-generating neural network using the estimate of the meta-gradient and the estimate of the policy gradient (operation 306).

For example, the system can update the parameters n of the target-generating neural network by applying the chain rule. Specifically, the system can compute the full meta-gradient ∇_{η}J(η) as the product of the gradient of the update procedure (∇_{η}, determined in operation 302) and the gradient of the objective (∇_{η}J(θ), determined in operation 304), such that ∇_{η}J(η)=∇_{η}θ∇_{θ}J(θ). The system then updates n in the direction of this gradient, for example, using gradient ascent: η←η+α∇_{η}J(η), where α is a pre-determined learning rate hyperparameter. When the system utilizes a population of training agents operating in diverse environments, the system aggregates the meta-gradients calculated from each agent. To prevent gradients from environments with large reward scales from dominating the update, the system may normalize the meta-gradient from each agent before averaging. For example, the system can apply a separate optimizer (such as Adam) to the meta-gradient calculated from each agent to generate a normalized gradient gᵢ, and then update the global parameters n using the average of these normalized gradients:

$$η ← η + \frac{1}{n} {\sum }_{i = 1}^{n} ADAM ( {g}_{i} ) .$$

Merely as a particular example, in some implementations inputs to the target generating neural network can include a selection from, or all of, those listed below (where N_{actions} is the number of actions and N_{emb} is the embedding size of the state- and action-conditional predictions):

| Feature | Shape | Description |
|---|---|---|
| r | scalar | The reward. |
| α | scalar | The action. |
| γ | scalar | A boolean episode-termination |
| | | indicator. |
| π | [N_{actions}] | The action probability for each |
| | | action. |
| y | [N_{emb}] | The agent's state-conditional |
| | | prediction. |
| z | [N_{emb}, N_{actions}] | The agent's action-conditional |
| | | prediction for each action. |
| μ | [N_{actions}] | The behavior policy's action |
| | | probability for each action. |
| value | scalar | The value estimate. |
| adv_retrace | scalar | The Retrace advantage estimate. |
| norm_adv_retrace | scalar | The normalized Retrace advantage |
| | | estimate. |
| action_value | [N_{actions}] | The action-value estimate for each |
| | | action. |
| adv | [N_{actions}] | The advantage estimate for each |
| | | action. |
| norm_adv | [N_{actions}] | A normalized advantage estimate |
| | | for each action. |

Once the target-generating neural network has been trained via the meta-learning process 300, it serves as an optimized update rule for training agents. Accordingly, the system can utilize the trained target-generating neural network to train an agent neural network (e.g., as described in process 200). In some implementations, after the agent neural network has been trained using the target-generating neural network, the system controls the agent using policy output generated by the agent neural network to perform instances of the task.

For example, if the agent is a (real-world) robot, the system uses the trained agent neural network to control the robot.

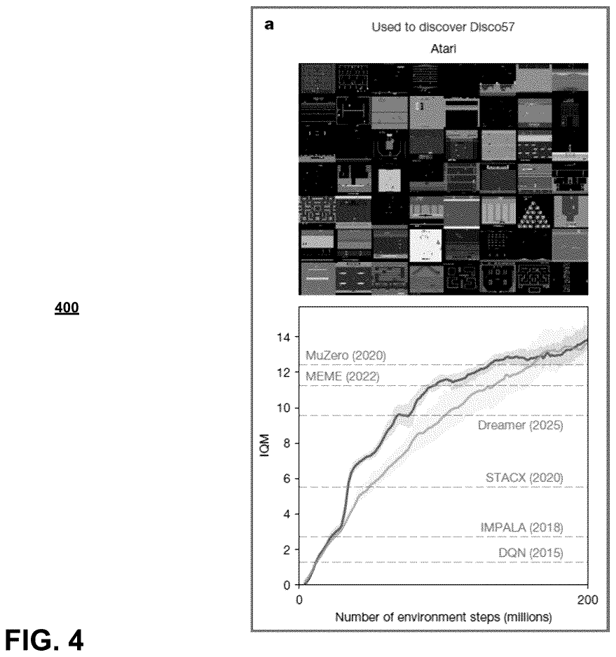

FIG. 4 shows an example 400 of performance of the described techniques.

In particular, example 400 shows a performance comparison between the described technique's use of a target-generating neural network to train an agent neural network (i.e., Disco57) and other techniques to train an agent neural network (i.e., DQN, Impala, STACX, Dreamer, MEME, MuZero).

The top portion of FIG. 4 displays a grid of screenshots from 57 Atari 2600 games the described techniques used to train the target-generation neural network, illustrating the diversity of the training environments.

The bottom portion of FIG. 4 is a plot illustrating the aggregate performance of the described techniques across the 57 Atari games. The x-axis represents the number of environment steps or transitions (in millions) experienced by a respective agent neural network within its specific game environment. The y-axis represents the Interquartile Mean (IQM) of human-normalized scores achieved by a population of 57 separate agent neural networks, where each agent neural network was trained on a different game using the same target-generating neural network. The solid curve labeled Disco57 tracks this aggregate IQM score as a function of the training steps taken by each agent neural network, representing the performance of the population trained using the target-generating neural network. The curve labelled Disco103 represents the aggregate performance of a similar population of agent neural networks trained using a target-generating neural network trained using larger set of environments. The shaded areas around the curves represent 95% confidence intervals. The horizontal dashed lines represent the final performance levels of agent neural networks generated using various other techniques, including MuZero, MEME, Dreamer, STACX, IMPALA, and DQN. As shown in the plot, the population of agent neural networks trained with the described techniques (Disco57 and Disco103) achieve a higher aggregate performance than other techniques.

The superior performance of the described techniques shown in FIG. 4 is enabled by the described technique's ability to train an agent neural network using a target-generating neural network. By processing the agent neural network's policy output and actions to generate a target policy output, the target-generating neural network effectively provides target outputs tailored to the specific challenges of the environment to train the agent neural network on. Furthermore, by including state-conditional and action-conditional prediction vectors in the agent output and generating corresponding targets for them, the described techniques enable the agent neural network to learn latent representations that capture critical task-relevant information without requiring pre-defined semantics.

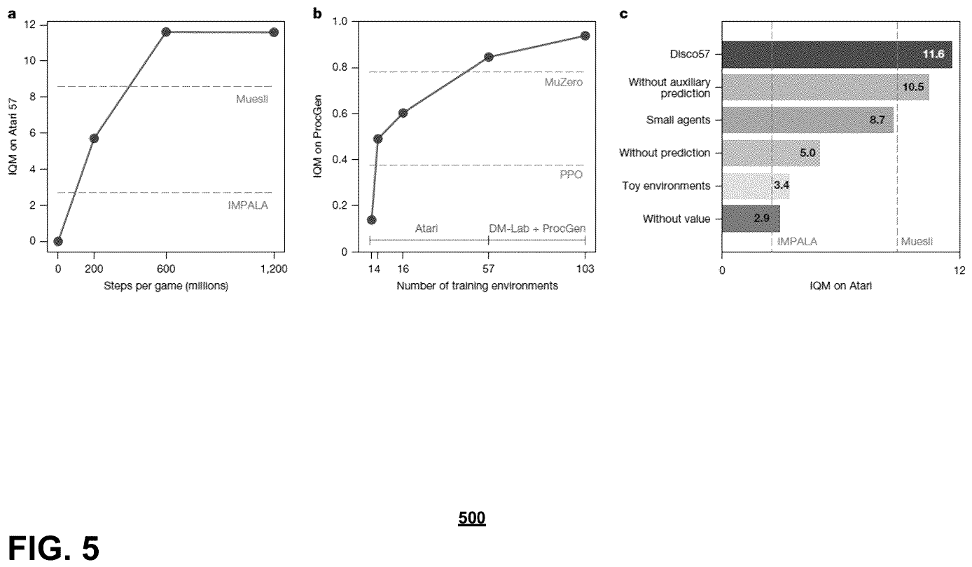

FIG. 5 shows an example 500 of performance of the described techniques.

In particular, example 500 shows three plots (a, b, c) showing various properties of the described techniques and the resulting performance of the agent neural network trained using the target-generating neural network.

The left plot (a) illustrates the training efficiency of the target-generation neural network, where the x-axis represents the number of transitions per trajectory used during the meta-training of the target-generation neural network (training the target-generating neural network on the meta-learning objective), and the y-axis represents the Interquartile Mean (IQM) score on the Atari 57 benchmark achieved by the resulting trained agent neural network. The plot shows the performance of Disco57 (the described techniques defined in example 400 above) improving as the number of number of transitions per trajectory increases, eventually surpassing other techniques for training an agent neural network such as Muesli and IMPALA, represented by horizontal dashed lines.

The efficiency curve in plot (a) highlights the effectiveness of training the target-generating neural network on a meta-learning objective, allowing the described techniques to discover a high-performance “rule” (i.e., train the target-generating neural network) within an efficient computational budget.

The middle plot (b) illustrates scalability, where the x-axis represents the number of training environments used (e.g., 14, 16, 57, 103) while training the target-generating neural network on the meta-learning objective, and the y-axis represents the IQM score on the ProcGen benchmark, which was not seen during training of the target-generating neural network. This plot demonstrates that training the target-generating neural network on a larger and more diverse set of environments leads to better generalization on unseen tasks, with performance approaching or exceeding other techniques like PPO and MuZero.

The scalability curve in plot (b) validates the benefit of utilizing a diverse set of training environments during training of the target-generating neural network, as increasing the number of environments directly improves the generalization capability of the trained agent neural network to control agents in unseen environments.

The right plot (c) illustrates an ablation study, showing the IQM on Atari for variations of the described techniques. The horizontal bars compare the performance of the described techniques, Disco57, against versions without specific components, such as “Without auxiliary prediction” (not including the auxiliary policy prediction output in the agent output or the target-generating input), “Without prediction” (not including the state-conditional prediction vector (y) and respective action-conditional prediction vector (z) for each of at least a subset of the actions in the agent output or the target-generating input), and “Without value” (not including action-value estimate for each of at least a subset of the actions in the agent output or the target-generating input). Vertical dashed lines indicate the performance of baseline techniques IMPALA and Muesli.

Plot (c) confirms the importance of including prediction vectors (state-conditional vector and action-conditional vectors) and action-value estimates in the agent output or target-generating input. Removing the prediction vectors (“Without prediction”) or the action-value estimates (“Without value”) results in a significant drop in performance, demonstrating that these elements are helpful for achieving improved performance.

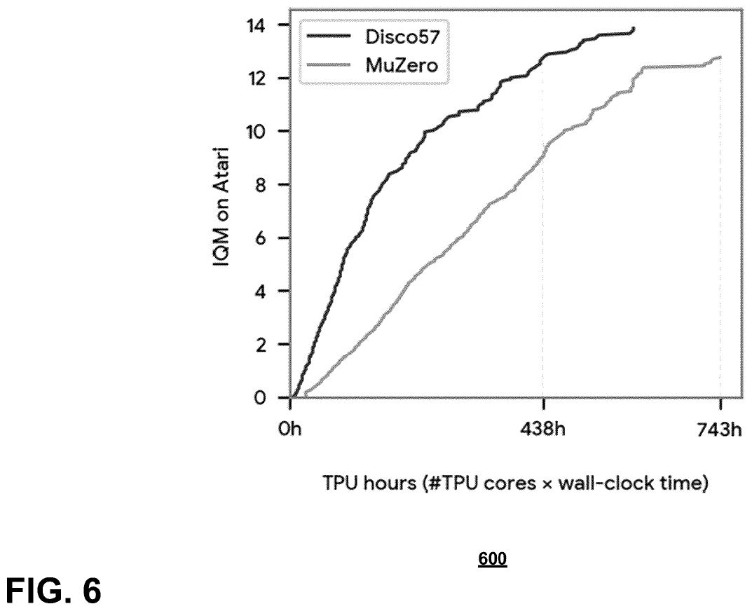

FIG. 6 shows an example 600 of performance of the described techniques.

In particular, example 600 shows a comparison of the computational cost required to achieve various performance levels on the Atari benchmark between an agent neural network trained using the described techniques (Disco57) and an agent trained using a different technique (MuZero algorithm). The x-axis represents the amount of computational resources consumed during training, measured in TPU hours (number of TPU cores multiplied by wall-clock time). The y-axis represents the performance on the Atari benchmark, measured by the Interquartile Mean (IQM) of human-normalized scores across the 57 Atari games. The curve labelled “Disco57” corresponds to the performance trajectory of the agent trained using the described target-generating neural network. The other curve labelled “MuZero” corresponds to the performance trajectory of another technique.

Example 600 demonstrates that the described techniques (“Disco57”) achieve higher performance scores significantly faster and with less computational expense than the other technique (“MuZero”). For example, the agent neural network trained with the described techniques reaches the final performance level of MuZero (approximately an IQM of 12.5) after consuming only about 438 TPU hours, whereas the other technique (MuZero) requires approximately 743 TPU hours to reach the same level. This indicates that the described techniques enable the agent neural network to reach state-of-the-art performance with approximately 40% less computation for training. Furthermore, training the agent neural network using the described techniques continues to improve beyond MuZero's final performance, eventually achieving a human-normalized Interquartile Mean (IQM) score of 13.86, which surpasses the performance of all existing techniques evaluated on that benchmark.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small, embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training an agent neural network to control a first agent in a first environment to perform a first task, the method comprising:
obtaining a training trajectory, the training trajectory comprising a sequence of transitions, each transition in the sequence comprising a respective observation characterizing a state of the first environment and an action performed by the first agent in response to the respective observation;
for each transition in the training trajectory:
processing an agent input comprising the respective observation in the transition using the agent neural network to generate an agent output that comprises a policy output that defines a respective score for each action in a set of actions; and
processing a target-generating input that comprises the policy output and the action in the transition using a target-generating neural network to generate a target-generating output that comprises a target policy output; and
training the agent neural network on a loss function that comprises a policy loss that measures, for each transition, an error between the policy output for the transition and the target policy output for the transition generated by the target-generating neural network.

2. The method of claim 1, wherein the target-generating input does not include the respective observation in the transition.

3. The method of claim 1, wherein each transition further comprises a respective reward received in response to the first agent performing the action in the transition and wherein the target-generating input further comprises the respective reward.

4. The method of claim 1, wherein:
the agent output further comprises a state-conditional prediction vector,
the target-generating input further comprises the state-conditional prediction vector,
the target-generating output further comprises a target state-conditional prediction vector, and
the loss function further comprises a state-condition prediction loss that measures, for each transition, an error between the state-conditional prediction vector for the transition and the target state-conditional prediction vector for the transition generated by the target-generating neural network.

5. The method of claim 4, wherein the state-conditional prediction vector is a latent vector in a first latent space.

6. The method of claim 1, wherein:
the agent output further comprises a respective action-conditional prediction vector for each of at least a subset of the actions,
the target-generating input further comprises the respective action-conditional prediction vectors,
the target-generating output further comprises a respective target action-conditional prediction vector for each of at least the subset of the actions, and
the loss function further comprises an action-condition prediction loss that measures, for each transition and for each of at least the subset of the actions, an error between the respective action-conditional prediction vector for the action and the respective target action-conditional prediction vector for the action generated by the target-generating neural network.

7. The method of claim 6, wherein each respective action-conditional prediction vector is a respective latent vector in a second latent space.

8. The method of claim 1, wherein the target-generating input further comprises an indicator variable that indicates whether the transition was a terminal transition in a task episode.

9. The method of claim 1, wherein the target-generating neural network is configured to, prior to processing a first transition in the sequence:
initialize a first hidden state of the target-generating neural network, and
for each transition:
process the target-generating input for the transition to update the first hidden state of the target-generating neural network, and
after updating the first hidden state, process a decoder input comprising the first hidden state using one or more decoder neural network heads to generate the target-generating output.

10. The method of claim 7, wherein transitions are arranged within the sequence according to a respective time step for each transition and wherein the first transition in the sequence is a transition with a latest time step.

11. The method of claim 9, wherein the agent neural network is trained on a sequence of trajectories that comprises the trajectory, wherein the target-generating neural network is configured to, prior to training the agent neural network:
initialize a second hidden state of the target-generating neural network, and
for each trajectory in the sequence, process the transitions in the trajectory to update the second hidden state.

12. The method of claim 11, wherein the decoder input comprises the second hidden state after being updated for a preceding trajectory in the sequence.

13. The method of claim 11, wherein processing the transitions in the trajectory to update the second hidden state comprises:
processing the transitions in the trajectory using an embedding neural network to generate an embedding of the trajectory; and
processing the embedding of the trajectory and the second hidden state using a recurrent neural network to update the second hidden state.

14. The method of claim 1, wherein:
the agent output further comprises a respective action-value estimate for each of at least a subset of the actions.

15. The method of claim 14, wherein the target-generating input further comprises the respective action-value estimates.

16. The method of claim 14, wherein
the loss function further comprises an action-value estimate loss that measures, for each transition, an error between the respective action-value estimates for the actions for the transition and a temporal-difference target for the transition.

17. The method of claim 1, wherein the target-generating neural network has been trained through meta-learning on a meta-learning objective that measures a performance of a plurality of training agent neural networks in controlling respective training agents in respective training environments.

18. The method of claim 17, wherein the meta-learning objective measures an expected time-discounted sum of rewards received by an agent controlled by one of the plurality of training agent neural networks.

19. The method of claim 18, wherein training the target-generating neural network on the meta-learning objective comprises repeatedly performing the following:
determining an estimate of a meta-gradient;
determining an estimate of a policy gradient; and
updating parameters of the target-generating neural network using the estimate of the meta-gradient and the estimate of the policy gradient.

20. The method of claim 1, wherein the agent neural network comprises:
an encoder configured to encode the agent input to generate an encoded representation; and
one or more neural network heads that are configured to process the encoded representation to generate the agent output.

21. A system comprising:
one or more computers; and
one or more storage devices storing instructions that, when executed by the one or more computers, cause the one or more computers to perform the operations for training an agent neural network to control a first agent in a first environment to perform a first task, the operations comprising:
obtaining a training trajectory, the training trajectory comprising a sequence of transitions, each transition in the sequence comprising a respective observation characterizing a state of the first environment and an action performed by the first agent in response to the respective observation;
for each transition in the training trajectory:
processing an agent input comprising the respective observation in the transition using the agent neural network to generate an agent output that comprises a policy output that defines a respective score for each action in a set of actions; and
processing a target-generating input that comprises the policy output and the action in the transition using a target-generating neural network to generate a target-generating output that comprises a target policy output; and
training the agent neural network on a loss function that comprises a policy loss that measures, for each transition, an error between the policy output for the transition and the target policy output for the transition generated by the target-generating neural network.

22. One or more non-transitory computer-readable storage media storing instructions that when executed by one or more computers cause the one or more computers to perform operations for training an agent neural network to control a first agent in a first environment to perform a first task, the operations comprising:
obtaining a training trajectory, the training trajectory comprising a sequence of transitions, each transition in the sequence comprising a respective observation characterizing a state of the first environment and an action performed by the first agent in response to the respective observation;
for each transition in the training trajectory:
processing an agent input comprising the respective observation in the transition using the agent neural network to generate an agent output that comprises a policy output that defines a respective score for each action in a set of actions; and
processing a target-generating input that comprises the policy output and the action in the transition using a target-generating neural network to generate a target-generating output that comprises a target policy output; and
training the agent neural network on a loss function that comprises a policy loss that measures, for each transition, an error between the policy output for the transition and the target policy output for the transition generated by the target-generating neural network.
